(19) United States
(12) Patent Application Publication
(10) Pub. No.: US 2026/0087514 A1
(43) Pub. Date: Mar. 26, 2026

(54) LOYALTY PROGRAM

(71) Applicant: MKN International LLC, Schaumburg, IL (US)

(72) Inventors: Michael DAMASCHKE, Willow Springs, IL (US); Kevin OLSON, Belvidere, IL (US); Nicholas LENNOX, Palatine, IL (US)

(21) Appl. No.: 19/338,774

(22) Filed: Sep. 24, 2025

Related U.S. Application Data
(60) Provisional application No. 63/698,928, filed on Sep. 25, 2024.

(51) Int. Cl. G06Q 30/0226; G06Q 30/0207; G06Q 40/04; H04W 12/06; H04W 12/63

(52) U.S. Cl. CPC G06Q 30/0231; G06Q 30/0237; G06Q 40/055; H04W 12/068; H04W 12/63

(57) ABSTRACT

A method of implementing a loyalty reward program is described. The technique requires minimal sign-up and sign-in requirements using a portable device, such as a cell phone, and a personal identification number. Rewards are earned based on one or more criteria, such as the amount of time spent at a location, and can be instantly redeemed through a kiosk. The rewards are most preferably cash, but could be in another form, such as a coupon or a physical item.

### FIELD OF THE INVENTION

The present disclosure is generally directed to methods of increasing one or more target behaviors among members of a population. More specifically, the subject matter of this application pertains to loyalty programs, particularly those in which rewards are redeemable upon earning them. More specifically, this disclosure pertains to loyalty programs in which earned rewards are fungible. Even more specifically, the subject matter of this application pertains to loyalty programs that reward members of a population for visiting and spending time within a defined area, and in which a reward is available when earned or may be left to accrue.

### BACKGROUND OF THE INVENTION

Several types of loyalty programs have been developed to incentivize consumer behavior. Progenitors of loyalty programs include merchants adding something to a customer's order (e.g., a “baker's dozen”) or offering a discount to repeat customers. In many ways, any action that increases a customer's goodwill toward a merchant can be considered a loyalty program, even if it is informal. Even indirect actions, such as mailing holiday cards to clients, may be seen as a type of loyalty program, as these actions can increase a merchant's goodwill

Many loyalty programs are more structured. A common type incentivizes a target behavior by assigning a fungible point score. Some airlines will award points to “frequent flyers” based on the distance flown per unit of time. Grocery stores may award points to customers based on the amount of money they spend at the store. Similarly, many credit cards return some percentage of the money charged on the card to the purchaser. In this way, a business is attempting to increase the likelihood of a rewarded customer returning to spend more money in the future.

To be maximally effective, the size of the reward should be carefully considered, being large enough to create goodwill and loyalty with the customer, but not so substantial that the merchant loses money. Higher-cost or higher-volume merchants or products may provide larger rewards than others. For example, casinos often offer high-stakes gamblers complimentary drinks, rooms, or entertainment experiences to increase the likelihood of that person returning to the casino.

When considering a loyalty program, a merchant should determine why they want to model a customer's behavior and how to do that. For a car dealership, credit card issuer, or other need-based businesses, a loyalty program may be less likely to increase the total amount a customer spends. Still, it may prevent the customer from being tempted by a competing business. A grocer may want to reward a customer's purchases, even though increasing spending at that particular grocer doesn't necessarily increase the total amount the customer will spend on groceries; it can decrease the amount the customer might pay at a competing store. Similarly, a successful loyalty program from a credit card issuer may not increase the total amount paid by a consumer, but will increase the use of a specific card. Accordingly, the most successful loyalty program in such markets could be the one with a reward program only slightly better than that of its competitors.

Conversely, some customer behavior is less need-based and more discretionary, and more likely to increase based on the number of visits or their duration. A fast-food restaurant's loyalty program, which periodically sends participants coupons for a free item, motivates people to visit and often buy additional items they wouldn't have purchased otherwise. Similarly, a department store's offer of a free or deeply discounted item to a loyal customer increases the chance of that customer encountering other items to purchase, particularly if the free or discounted item is located at the back of the store. In other words, a more enticing reward may be needed to cajole one to spend more than they need to on some item or experience.

For more discretionary markets, an increase in the number and duration of purchasing opportunities is known to increase the number of purchases. However, as discretionary markets are, by definition, not essential, the rewards offered through a loyalty program must be substantial enough to encourage repeated and more extended visits, but not so significant as to inordinately cut into merchant profits. That reward level is dynamic and varies according to known and unknown variables, making it difficult, if not impossible, to guess.

Loyalty rewards must be realized for customers to feel maximally rewarded for their behavior. If a loyalty program rewards points for a specific activity, but those points expire too quickly or are only redeemable for something the customer doesn't want, the value of the reward diminishes. Similarly, if rewards can only be redeemed in the future, for example, as a discount on a subsequent visit, the excitement felt from earning a reward is dampened.

It would be preferable to have a loyalty program that increases the frequency and duration of visits to a business, while also allowing the company to adjust the reward schedule and the size of the reward to maximize the occurrence of a desired behavior without inordinately decreasing profits. Furthermore, a preferred loyalty program would offer the option of near-instant redemption of a highly desired reward.

### SUMMARY OF THE INVENTION

The subject matter of this application includes a loyalty program that rewards visits to a location, as well as the duration of such visits, and a system for implementing the program. The loyalty program comprises a set of instructions stored on a non-transitory computer-readable medium accessible by a computerized kiosk. These instructions may be selected from a menu of sample or exemplary programs. Each of these sets of instructions comprises one or more reward parameters, at least one of which may be modified by a user. The computerized kiosk also gathers participant data and may dynamically adjust the reward parameters. The automated kiosk determines loyalty rewards based on the participant's data and calculates them according to an algorithm contained on the computer-readable medium. Participants may, at any time, interact with the computerized kiosk to monitor their earned rewards and withdraw the rewards. In most highly preferred embodiments, the rewards are available as cash and may also be available in other forms.

The subject matter of this application is further directed to a computer-implemented method for monitoring participant behavior and calculating a reward based on set targets. The method includes a check-in procedure, a check-out procedure, and the measurement of the time lapsed between check-in and check-out. The method further comprises one or more duration targets and a reward calculation procedure.

The subject matter of this application is further directed toward a kiosk comprising a microprocessor and a memory device. The memory device stores the code corresponding to the computer-implemented method in a manner readable and executable by the microprocessor. The memory device may be rewritten with new code, all or in part, to modify the reward parameters. The microprocessor is also adapted to sample data from the surroundings, particularly data on the behaviors of individual participants. This data, in conjunction with the reward parameters, is operated on by the microprocessor to calculate the reward earned by a participant and store this earned reward data on a memory device. The kiosk is located within an establishment and administered by an administrator. Further, it comprises hardware adapted to eject one or more tokens representing the earned reward when a participant selects to receive the reward.

In a preferred embodiment of the subject matter of this application, the ejection of a token is physical and intended to be removed by the participant. In other exemplary embodiments, the ejection could be an electronic transfer to an account controlled by the participant. The token may be a fungible currency, such as fiat, commodity, or cryptocurrency; alternatively, the token may be non-fungible, such as a coupon or a ticket exchangeable for goods and services.

In another embodiment of the subject matter of this application, the kiosk includes an input device that a participant uses to log their proximity to the kiosk. In other embodiments, the input device gathers information about the proximity of a participant with Bluetooth or another suitable wireless protocol. Most preferred embodiments include a confirmation from the participant following proximity detection, such as a short alphanumeric code being texted to the participant's cell phone or similar device, which must be entered into the kiosk to confirm proximity and reduce false logs.

In most highly preferred embodiments, each kiosk is in wireless communication with one or more other similar kiosks forming a network. This network may be a peer-to-peer or, preferably, a client-server network. The network enables connected kiosks to share participant information, including identifying details, allowing a single log-in credential to be used at any networked kiosk.

In other preferred embodiments, the reward parameters are adjustable by individuals with administrative access to the kiosk. Such adjustments may be manually entered into the microprocessor and memory device of the kiosk or may be entered on another device, which is then able to connect to and push the adjusted parameters to the kiosk.

In yet other embodiments, the kiosk may communicate with another device or system to administer the award. Such other devices or systems may include, e.g., an ordering system for the establishment in which an award is a food item, and a ticketing platform if the prize is event tickets.

### BRIEF DESCRIPTION OF DRAWINGS

FIG. 1 illustrates a sequence of events in an embodiment of the subject matter.

FIG. 2 illustrates the user interface when registering an account.

FIG. 3 illustrates the flow of actions of the loyalty program.

FIG. 4 illustrates one way a kiosk can alert a user to an available reward.

FIG. 5 illustrates part of the workflow of an embodiment of the subject matter.

FIG. 6 illustrates the relationship between activity monitoring and awards.

FIG. 7 illustrates a portion of an embodiment that includes an administrative node.

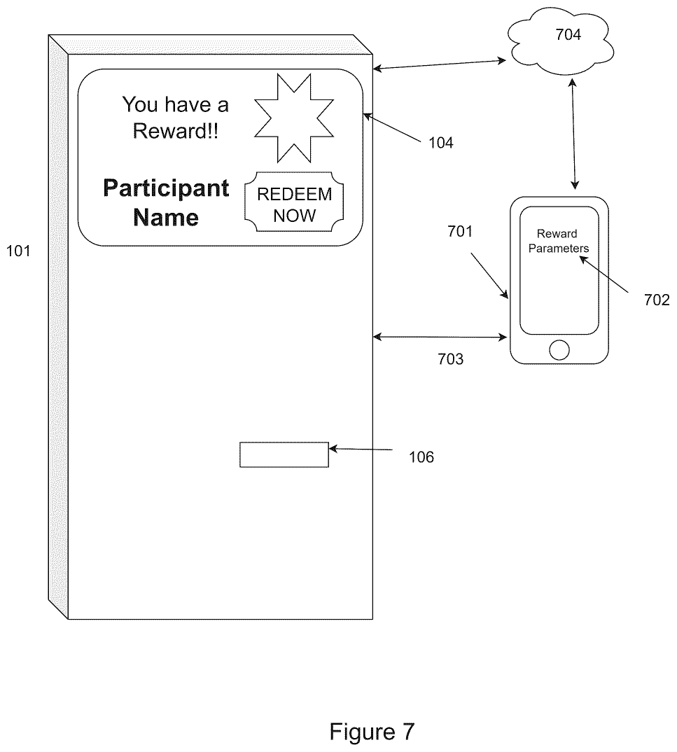

The same reference numbers will be used throughout the drawings to represent the same aspects wherever possible.

### DETAILED DESCRIPTION OF THE INVENTION

While the embodiments illustrated in the figures and described herein are presently preferred, these embodiments are offered by way of example only. Accordingly, the present application is not limited to a particular embodiment but extends to various modifications that nevertheless fall within the scope of the appended claims. The order or sequence of any processes or method steps may be varied or re-sequenced according to alternative embodiments.

It is important to note that the construction and arrangement of the various exemplary embodiments are illustrative only. Although only a few embodiments have been described in detail in this disclosure, those skilled in the art who review this disclosure will readily appreciate that many modifications are possible (e.g., variations in input/output devices, the types of rewards, the behaviors measured, sizes, dimensions, structures, shapes, and proportions of the various elements, values of parameters, mounting arrangements, use of materials, colors, orientations, etc.) without materially departing from the novel teachings and advantages of the subject matter recited in the claims. For example, elements shown as integrally formed may be constructed of multiple parts or elements, the position of elements may be reversed or otherwise varied, and the nature or number of discrete elements or positions may be altered or varied. Accordingly, all such modifications are intended to be included within the scope of the present application. The order or sequence of any process or method steps may be varied or re-sequenced according to alternative embodiments. In the claims, any means-plus-function clause is intended to cover the structures described herein as performing the recited function, not only structural equivalents, but also equivalent structures. Other substitutions, modifications, changes, and omissions may be made in the design, operating conditions, and arrangement of the exemplary embodiments without departing from the scope of the present application.

The uses of the verbs ‘include’ and ‘have’ should be understood to mean ‘comprise,’ i.e., the terms are inclusive and open-ended, and do not exclude additional elements or steps. For ease of drafting and understanding the subject matter of this application, the subject matter of this application is discussed and detailed in the context of a loyalty program encoded by software running on appropriate hardware contained or accessible by a kiosk, which calculates a reward based on the duration of a participant's visit to an establishment and dispenses this loyalty reward when the participant so directs. The discussion of such exemplary uses should not be used to narrow the scope of the claims.

As used here, a “kiosk” is a device capable of executing software that encodes a loyalty program and receives data input, which the software uses to determine output and also emits, ejects, or otherwise dispenses the determined output. An “administrator” is one with administrative access to a kiosk, such as a programmer, technician, owner, or custodian, and who may make or direct another to make changes to the software or to the manner in which the software determines output. A “participant” is one whose behavior is sampled by the kiosk and who can earn and receive a loyalty reward from the kiosk. A “reward” or “award” is an item of value, the magnitude of which is determined by the parameters of the loyalty program and the participant's behavior.

Each drawing callout has three numbers. The first is intended to indicate the figure that first shows the referenced point of interest or shows the referenced point of interest in the most transparent manner. Number callouts in the text are not necessarily in order. Drawings are not necessarily to scale and may omit supportive structures that are unclaimed, but that would be obvious to one in a relevant field of art.

A system for implementing a loyalty program comprises a kiosk with a microprocessor (a “processing node”), a memory storage device (a “memory node”), an input device (an “input node”), an internal physical storage unit, and a physical output. In use, the physical storage unit holds a number of tokens. The kiosk further comprises a mechanical means for delivering a known quantity of tokens from within the physical storage to outside the kiosk through the physical output.

The memory node stores a set of instructions encoding the details of the loyalty program, which are executed by the processing node.

Most highly preferred embodiments further comprise at least one remote input device and at least one remote output device. Preferably, each said remote input and remote output device is wirelessly connected to the kiosk in a peer-to-peer network. Additionally, most preferred embodiments of the loyalty program are comprised of at least two kiosks, which may be connected via peer-to-peer or a client-server network.

To illustrate and more fully disclose the subject matter of this application, several embodiments are described in detail below. No embodiment described is necessarily invariable, and new embodiments may be put together by combining portions of one or more of the disclosed embodiments or by altering the targets, rewards, and exchanges.

### I.

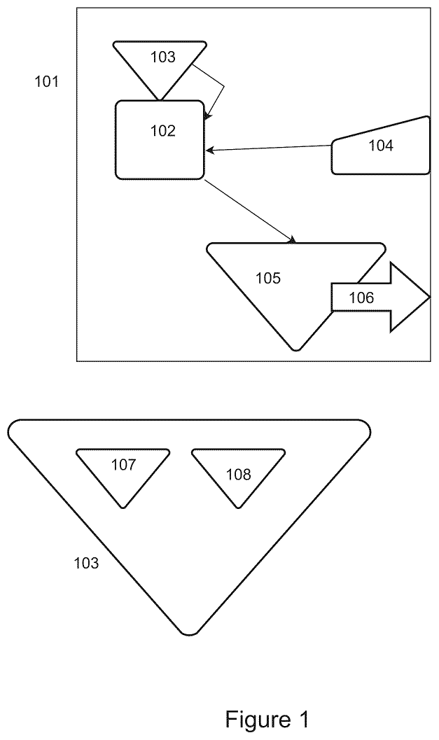

FIG. 1 illustrates an embodiment of the subject matter of this application. A loyalty program is implemented with the use of a kiosk (101) comprised of a microprocessor (102) and a memory device (103), an input device (104), a physical storage unit (105), and a physical output port (106). The kiosk is adapted to eject at least part of the contents of the physical storage unit through the physical output port in response to specific inputs.

The memory device may include or store a primary process (107), which may include one or more sub-or co-processes (108) that are executable by the microprocessor. In preferred embodiments, the primary process provides the actionable code necessary to run core processes on the kiosk, such as logging input and encoding input, ejecting items from within the physical storage unit, and making calls to a sub-process. Furthermore, a sub-process may include reward parameters used by the primary process to calculate the rewarded behavior and the corresponding reward amount.

A typical battery of events in a disclosed loyalty program between the initial login and payout begins with the placement of a kiosk, as described above, in an establishment. A person at the establishment can become a participant in the loyalty program by entering some identifying information into the kiosk or interacting with the input device. In most preferred embodiments, the information needed to establish participation is brief to make participation as effortless as possible; for example, nothing more than a name (201) and cellular phone number (202) may suffice. At this point, optimally, an automated text message or similar is sent to the person's cell phone (203) containing a personal identification code (204). The person is then prompted to enter this code at the kiosk to confirm the phone number (206). After the initial log-in, an account is created for the person who is now a participant (301). In many cases, the initial account creation results in the first loyalty point or points being credited to the account.

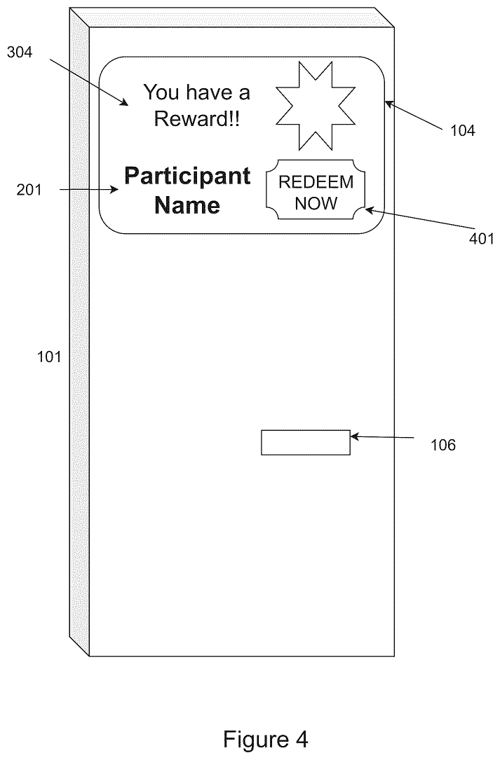

The parameters of the loyalty program are comprised of actions (302), targets (303), rewards (306), and a value or exchange rate (305), all of which are encoded in the memory device. For example, a target may be reached by a participant logging into the kiosk ten times, and the reward for achieving that target may be 10 points (304), in which 10 points has an exchange rate (305) of, e.g., five US dollars. In such a loyalty program, after the participant reaches a target (302), the cash reward can be immediately withdrawn from the physical output port (106) of the kiosk (101) displaying an award screen (e.g., FIG. 4). Optionally, a participant would forgo the instant withdrawal of the reward and “let it ride” until a subsequent target is reached. In such an embodiment, for example, the second target may be reached with 20 log-ins, with this target being rewarded with 10 points plus some amount of additional points awarded for not taking the earlier award. The program may persist as described until the participant stops logging into the kiosk.

### II.

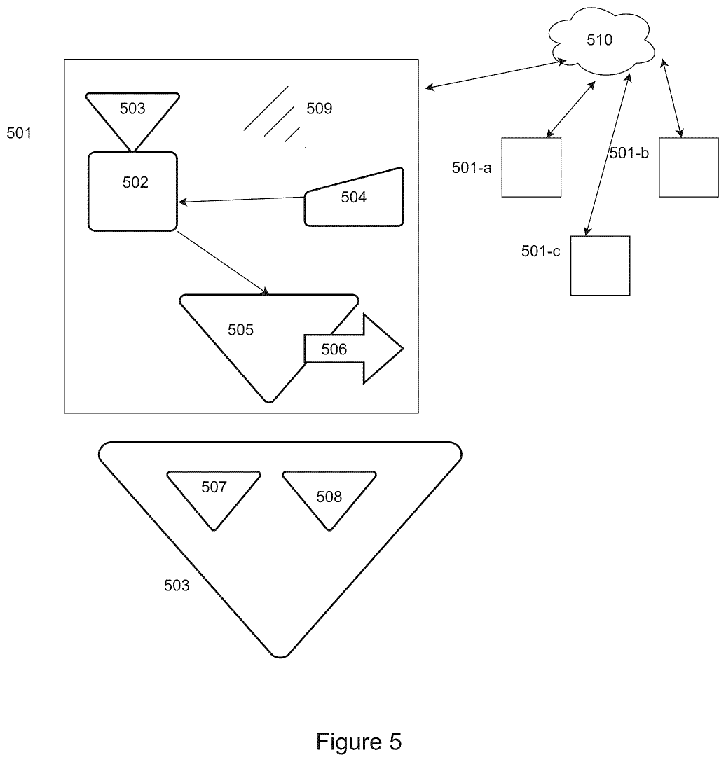

FIG. 5 illustrates an embodiment of the subject matter of this application. A loyalty program is implemented with the use of a plurality of kiosks (501, 501-a, 501-b, 501-c), each comprised of a microprocessor (502) and a memory device (503), an input device, networking hardware (509), a physical storage unit (505), and a physical output port (506). Each said kiosk is adapted to eject at least part of the contents of the physical storage unit through the physical output port in response to specific inputs.

Each said kiosk (501) is networked with at least one other kiosk (e.g., 501a, 501-b, 501-c). Such networking may be peer-to-peer or may be a client-server network (e.g., 510).

Each said memory device may include or store a primary process (507), which may include one or more sub-or co-processes (508) that are executable by the microprocessor. In preferred embodiments, the primary process provides the actionable code necessary to run core processes on the kiosk, such as, e.g., logging input and encoding input, networking processes, ejecting items from within the physical storage unit, and making calls to a sub-process. Furthermore, a sub-process may include reward parameters used by the primary process to calculate the rewarded behavior and the corresponding reward amount.

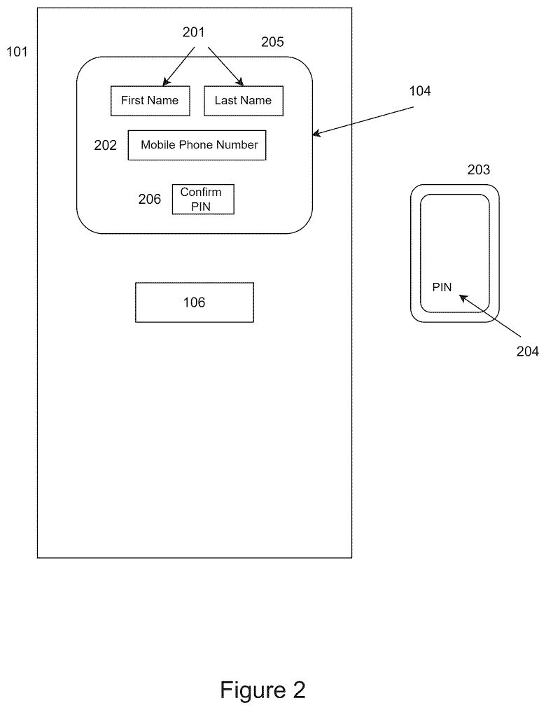

A typical battery of events in a disclosed loyalty program between the initial log-in and payout begins with the placement of a kiosk, as described above, in an establishment. A person at the establishment can become a participant in the loyalty program by entering some identifying information into the initiating kiosk. In most preferred embodiments, the information needed to establish participation is brief to make participation as effortless as possible (FIG. 2). For example, in some preferred embodiments of the subject matter of this application, a person may download an application to their cellular phone, which may create a transient network with the initiating kiosk. At this point, optimally, an automated text message or similar is sent to the person's cell phone containing a personal identification code. The person is then prompted to enter this code in the application to confirm the phone number. After the initial log-in, an account is created for the person who is now a participant, and identifying information is transmitted across the network to one or more receiving kiosks. In a most highly preferred embodiment, the identifying information transmitted from the initiating kiosk to the receiving kiosk or kiosks is utilized by the receiving kiosks to expedite the participants'logging into other networked kiosks (e.g., 501-a, 501-b, 501-c). In this manner, a participant may log into other networked kiosks located in other establishments without needing to create a separate account. In many cases, the initial account creation results in the first loyalty point or points being credited to the account. Subsequent log-in procedures can be accomplished by the participant launching the application, which establishes a temporary network with the kiosk and identifies the participant's cellular phone. Alternatively, the participant can enter their mobile number and verify the code as previously described.

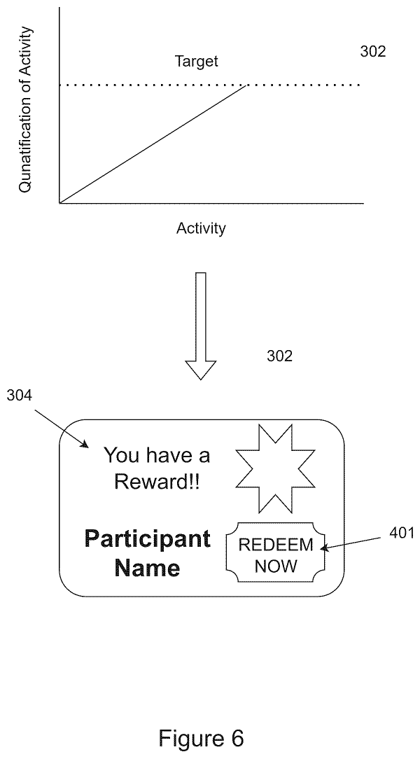

The parameters of the loyalty program comprise targets and rewards (see FIG. 6), all of which are encoded in the memory device. For example, a target may be reached by a participant being within an establishment for a certain amount of time in a day, and the reward for achieving that target may be equal to ten US dollars. In certain embodiments, the time spent within an establishment is approximated by having the participant periodically repeat the login procedure. In certain other embodiments, the proximity of a participant to the kiosk could be determined by Bluetooth or a similar signal or geofencing. In certain embodiments of the subject matter of this application, after the participant reaches a target, the reward can be immediately withdrawn from the kiosk in cash or redeemed in another manner. For example, if the establishment is a restaurant, the participant could elect to receive a food item selected from a list instead of cash. In such embodiments, the participant would indicate their preference in the cellular phone application, which would connect to the network and send a message to the receiving node located in the kitchen, prompting the preparation of the selected food item. In other embodiments, the cellular phone application could interface with and communicate a food order to the restaurant's existing wireless ordering system. Optionally, a participant would forgo the instant withdrawal of the reward and “let it ride” until a subsequent target is reached. In such programs, the amount rewarded for each subsequent target may increase to encourage participants to work toward a goal. Each receiving node is located within the same establishment as the kiosk the participant is currently logged into, and is restricted to receiving reward redemption requests originating within the same establishment. The reward parameters encoded in the sub-process may limit the redeemability of non-cash rewards to those rewards earned by reaching targets within a subset of networked kiosks.

### III.

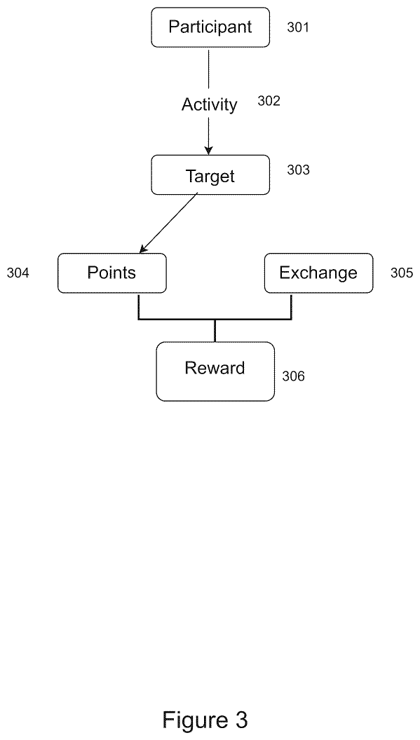

FIG. 3 illustrates an embodiment of the subject matter of this application. A loyalty program is implemented with the use of a plurality of kiosks (501, 501-a, 501-b, 501-c)), each comprised of a microprocessor (502) and a memory device (503), an input device such as a touch screen (104, 504), networking hardware, a physical storage unit (505), and a physical output port (506, 106). Each said kiosk is adapted to eject at least part of the contents of the physical storage unit through the physical output port in response to specific inputs.

Each said kiosk is networked with at least one other kiosk (e.g., 501, 501-a, 501-b, 501-c). Such networking may be peer-to-peer or may be a client-server network (510) Each said memory device (503) may include or store a primary process (507), which may include one or more sub-or co-processes (508) that are executable by the microprocessor (502). In preferred embodiments, the primary process provides the actionable code necessary to run core processes on the kiosk, such as, e.g., logging input and encoding input, networking processes, ejecting items from within the physical storage unit, and making calls to a sub-process. Furthermore, a sub-process may include reward parameters used by the primary process to calculate the rewarded behavior and the corresponding reward amount.

A typical battery of events in a disclosed loyalty program between the initial login and payout begins with the placement of a kiosk as described above (FIG. 2) in an establishment. A person at the establishment can become a participant in the loyalty program by entering their identifying information into the initiating kiosk through interaction with the input device. In most preferred embodiments, the information needed to establish participation is brief to make participation as effortless as possible; for example, nothing more than a name and cellular phone (202) number may suffice. At this point, optimally, an automated text message or similar is sent to the person's cell phone containing a personal identification code. The person is then prompted to enter this code at the kiosk to confirm the phone number. After the initial log-in, an account is created for the participant, and identifying information is transmitted across the network to one or more receiving kiosks. In a most highly preferred embodiment, the identifying information transmitted from the initiating kiosk to the receiving kiosk or kiosks is utilized by the receiving kiosks to expedite the participants'logging into networked kiosks. In this manner, a participant may log into other networked kiosks located in other establishments without needing to create a separate account. In many cases, the initial account creation results in the first loyalty point or points being credited to the account.

The parameters of the loyalty program are comprised of targets and rewards, all of which are encoded in the memory device. For example, a target may be reached by a participant logging into at least one of the networked kiosks ten times within 30 30-day period, and the reward for reaching that target may be ten US dollars. In such a loyalty program, after the participant reaches a target the cash reward can be immediately withdrawn from the kiosk. Optionally, a participant would forgo the instant withdrawal of the reward and “let it ride” until a subsequent target is reached. In such programs, the amount rewarded for each subsequent target may increase to encourage participants to work toward a goal. In such embodiments, rewards may be earned at any kiosk and retrieved from any kiosk.

### IV.

FIG. 4 illustrates an embodiment of the subject matter of this application. A loyalty program is implemented with the use of a kiosk (101) comprised of a microprocessor (102) and a memory device (103), an input device such as a touch screen (104), network hardware, (e.g., 509) an administrator node (701), at least one physical storage unit (105, 505), and a physical output port (106, 506). The kiosk is adapted to eject at least part of the contents of each physical storage unit through the physical output port in response to signals received and the parameters of the loyalty program.

The memory device may include or store a main process which may include one or more sub- or co-processes that are executable by the microprocessor. In preferred embodiments, the main process provides the actionable code necessary to run core processes on the kiosk, such as e.g. logging input and encoding input, ejecting items from within the physical storage unit, networking, and making calls to a sub-process. Further, a sub-process may include reward parameters used by the primary process to calculate rewarded behavior and reward amount.

A typical battery of events in a disclosed loyalty program between the initial log in and payout begins with the placement of a kiosk as described above in an establishment. A person at the establishment can become a participant in the loyalty program by entering some identifying information into the kiosk by interacting with the input device. In most preferred embodiments, the information needed to establish participation is brief to make participation as effortless as possible, for example, nothing more than a name and cellular phone number may suffice (see FIG. 2). At this point, optimally, an automated text message or similar is sent to the person's cell phone containing a personal identification code. The person is then prompted to enter this code at the kiosk to confirm their phone number. People also become participants in the loyalty program through registration on a cellular phone application or other suitable means. After the initial log-in, an account is created for the person who is now a participant. In many cases, the initial account creation results in the first loyalty point or points being credited to the account.

The parameters of the loyalty program are comprised of targets and rewards (see FIG. 6, and two or more values or exchange rates, all of which are encoded in the memory device. For example, a target may be reached by a participant logging into a kiosk once an hour following the first login of the day, and the reward for reaching that target may be 10 points, in which 10 points could be exchanged or redeemed an amount of cash or one or more coupons or vouchers. In this way a participant may, upon reaching some reward level collect some reward such as, for example: 20 US dollars or a voucher for a sweatshirt, or a coupon for 50% off a purchase of $50 from the establishment, or any number of other rewards. In such a loyalty program, after the participant reaches a target, the reward, either as cash or some other instrument, can be immediately withdrawn from the kiosk (101).

The parameters of the loyalty program are preferably capable of being modified through the use of the administrator node (701). In a preferred embodiment, the administrator node is a tablet computer or similar computing node running an application (702) that allows an administrator to adjust the targets, rewards, and exchange rates of the program (FIG. 6). The administrative software may be stored locally on a memory module and executed on the administrator node; or the software could be on the memory device of the kiosk, or, in some embodiments, accessed by the administrator node from a local network (702) or cloud-based server (704). The software may push updated parameters to the kiosk, or the sub-process being called by the primary process may be located on the memory device of the administrator node

The above exemplary embodiments disclose the salient features of the most preferred embodiments of the subject matter of this application. To further disclose the subject matter of this application, the most highly preferred embodiment is described below in further detail, from the step of a person becoming a participant, to that participant receiving one or more cash rewards.

A loyalty network comprises member establishments having hardware that is networked to other member establishments. Each member-establishment may have a loyalty program distinct from the loyalty program of every other member-establishment. A person enters a member establishment that participates in a loyalty program disclosed herein. To become a participant, the person interacts with a networked node (kiosk). Each kiosk (101) has a memory module (103), a microprocessor (102) capable of executing code stored on the memory module, networking hardware (e.g., 509), and an input such as a touch screen (104). Preferably, the steps required to create a profile are minimal to encourage participation and increase the number of new profiles that can be made per unit of time (FIG. 2). After selecting an option to create a profile, the person enters their name and mobile number (202). The software running on the kiosk through the networking hardware sends a personal identification number (PIN) to the person's mobile device (203) via a Short Message Service (SMS) message or similar communication method (204). The person enters the PIN, confirming their mobile number, and the software on the kiosk creates an account for the person. The kiosk communicates the creation of a new account to a central server, which is in communication with each kiosk within the network. In this way, as the participant enters other member establishments, a new account is not needed.

With account creation, the participant earns their first point. The manner in which points are awarded and the rewards earned at each point milestone are flexible and can be set by the administrator of each establishment. In the exemplary program, a participant can earn a point each day by checking in. The check-in process is ideally minimal: the participant enters their mobile number on a kiosk, a PIN is sent to the mobile device, which is entered into the kiosk, and the participant is rewarded a point, similar to the initial profile creation. The participant may earn additional points by checking in again after a set time. For example, the initial check-in would award a point and start a timer for a specified number of minutes. When that number of minutes is reached, the participant may check in again and earn an additional point (FIG. 3, FIG. 6). When the participant earns a certain number of points, they are alerted to the availability of a reward when they interact with the kiosk. They can withdraw that reward in the form of cash dispensed by the kiosk (101, 106).

Participants may opt in to receive additional promotional messages. Such messages may include a personalized bonus. For example, a participant may receive extra points for checking in on their birthday or may earn additional points for checking in several days in a row.

Each member-establishment may have a loyalty program isolated from the loyalty programs of other member-establishments or may be linked to others. In this manner, unrelated or competing businesses may still be member establishments, and each can access a participant's account. Still, points earned at a location are only redeemable at that location. Cooperative or commonly owned establishments may allow a participant to earn points at several locations and redeem rewards at any networked kiosk.

To withdraw the reward, the participant interacts with the kiosk (101), likely through the touch screen (104), and initiates a “redeem” routine (401) which dispenses the reward or rewards through the physical output (106) as described earlier.

We claim:

1. A system for rewarding target behaviors comprising:
Providing a kiosk located within a defined area, said kiosk comprising:
a user interface configured to receive user input;
a networking means in communication with at least one other instance of said kiosk; and an internal storage space adapted to hold a plurality of tokens;
in which at least one token is an item of fungible currency; and
in which at least one token is exchangeable for a specified good or service.

2. The system of claim 1, wherein said kiosk is configured to execute a method of registering and confirming a user, said method comprising generating a unique code and transmitting the unique code to a receiving device.

3. The system of claim 2, wherein said receiving device is a mobile telephone number.

4. The system of claim 1, wherein said kiosk further comprises instructions for tracking a variable.

5. The system of claim 4 in which the variable is the progression toward a goal defined as a set number of confirmations of a registrant within a defined time period.

6. The system of claim 4 in which the variable is the progression toward a goal defined as a target time elapsed proximal to said kiosk.

7. The system of claim 5, wherein said kiosk is further configured to provide one or more tokens immediately redeemable upon determination that the user has reached said target behavior goal.

8. A method for facilitating behavior-based rewards, comprising
defining an area;
providing a kiosk within said area, said kiosk comprising a user interface, a networking means in communication with at least one other instance of said kiosk, and an internal storage space adapted to hold a plurality of tokens;
said internal storage space having storing at least one token, in which said token may be either an item of currency or exchangeable for a specified good or service, and
said kiosk executing a registration and identification procedure in which a user enters a unique personal code.

9. The method of claim 8, wherein said unique personal code comprises a mobile telephone number.

10. The method of claim 8, further comprising setting a target behavior goal selected from the group consisting of the number of visits per unit time and a target visit duration.

11. The method of claim 10, further comprising tracking user progress toward said target behavior goal, including:
requiring the user to check in at said kiosk; and
confirming user presence
in which user presence is determined by a periodic check-in procedure or a geolocation means.

12. The method of claim 11, further comprising allowing the user to withdraw awarded tokens upon reaching said target behavior goal.

13. A non-transitory computer-readable medium comprising instructions that, when executed by one or more processors, cause the kiosk to perform a method comprising:
defining an area in which the kiosk is located;
providing a user interface configured to receive user input;
establishing communications between a networking means of the kiosk and at least one other instance of a kiosk;
maintaining, within an internal storage space, a plurality of tokens in which each token is either currency or is exchangeable for a good or service;
executing a registration procedure in which a user enters a unique personal code; and
tracking user progress toward a target behavior goal.

14. The computer-readable medium of claim 13, wherein the unique personal code comprises a mobile telephone number.

15. The computer-readable medium of claim 13, wherein the target behavior goal comprises a number of visits per unit time or the duration of a visit.

16. The computer-readable medium of claim 15, wherein the instructions further cause the kiosk to award the user with an immediately redeemable award upon determining that the user has reached the target behavior goal.
